(19) United States
(12) Patent Application Publication
(10) Pub. No.: US 2025/0343917 A1
(43) Pub. Date: Nov. 6, 2025

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Yaojun WU, Beijing (CN); Semih Esenlik, Los Angeles, CA (US); Zhaobin Zhang, Los Angeles, CA (US); Meng Wang, Beijing (CN); Kai Zhang, Los Angeles, CA (US); Li Zhang, Los Angeles, CA (US)

(21) Appl. No.: 19/268,690

(22) Filed: Jul. 14, 2025

Related U.S. Application Data
(63) Continuation of application No. PCT/CN2024/072154, filed on Jan. 12, 2024.

(30) Foreign Application Priority Data
Jan. 13, 2023 (WO) PCT/CN2023/072024

(51) Int. Cl. H04N 19/136; H04N 19/169; H04N 19/186; H04N 19/70

(52) U.S. Cl. CPC H04N 19/136; H04N 19/186; H04N 19/1887; H04N 19/70

(57) ABSTRACT

Embodiments of the present disclosure provide a solution for visual data processing. In the method, for a conversion between a current visual unit of visual data and a bitstream of the visual data, a plurality of codewords in the bitstream is determined. A codeword is associated with at least one of: semantic element information, or latent variable information of at least one color component of the current visual unit. The conversion is performed based on the plurality of codewords.

### CROSS-REFERENCE TO RELATED APPLICATIONS

This application is a continuation of International Application No. PCT/CN2024/072154, filed on Jan. 12, 2024, which claims the benefit of International Application No. PCT/CN2023/072024 filed on Jan. 13, 2023. The entire contents of these applications are hereby incorporated by reference in their entireties.

### FIELDS

Embodiments of the present disclosure relates generally to visual data processing techniques, and more particularly, to a plurality of codewords in the bitstream.

### BACKGROUND

Image/video compression is an essential technique to reduce the costs of image/video transmission and storage in a lossless or lossy manner. Image/video compression techniques can be divided into two branches, the classical video coding methods and the neural-network-based video compression methods. Classical video coding schemes adopt transform-based solutions, in which researchers have exploited statistical dependency in the latent variables (e.g., wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs. Coding efficiency of image/video coding is generally expected to be further improved.

### SUMMARY

Embodiments of the present disclosure provide a solution for visual data processing.

In a first aspect, a method for visual data processing is proposed. The method comprises: determining, for a conversion between a current visual unit of visual data and a bitstream of the visual data, a plurality of codewords in the bitstream, a codeword being associated with at least one of: semantic element information, or latent variable information of at least one color component of the current visual unit; and performing the conversion based on the plurality of codewords. The method in accordance with the first aspect of the present disclosure applies a plurality of codewords in the bitstream instead of a single codeword. In this way, the coding efficiency and/or coding effectiveness can thus be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for data processing. The method comprises: determining a plurality of codewords in the bitstream, a codeword being associated with at least one of: semantic element information, or latent variable information of at least one color component of a current visual unit of the visual data; and generating the bitstream based on the plurality of codewords.

In a fifth aspect, a method for storing a bitstream of a video is proposed. The method comprises: determining a plurality of codewords in the bitstream, a codeword being associated with at least one of: semantic element information, or latent variable information of at least one color component of a current visual unit of the visual data; generating the bitstream based on the plurality of codewords; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8 illustrates a structure of the bitstream in the current learned image compression framework;

FIG. 9 illustrates an example of a bitstream structure in accordance with embodiments of the present disclosure;

FIG. 10 illustrates another example of a bitstream structure in accordance with embodiments of the present disclosure;

FIG. 11 illustrates another example of a bitstream structure in accordance with embodiments of the present disclosure;

FIG. 12 illustrates another example of a bitstream structure in accordance with embodiments of the present disclosure;

FIG. 13 illustrates a flowchart of a method for visual data processing in accordance with embodiments of the present disclosure; and

FIG. 14 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “visual data” may refer to image data or video data. The term “visual data processing” may refer to image processing or video processing. The term “visual data coding” may refer to image coding or video coding. The term “coding visual data” may refer to “encoding visual data (for example, encoding visual data into a bitstream)” and/or “decoding visual data (for example, decoding visual data from a bitstream”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

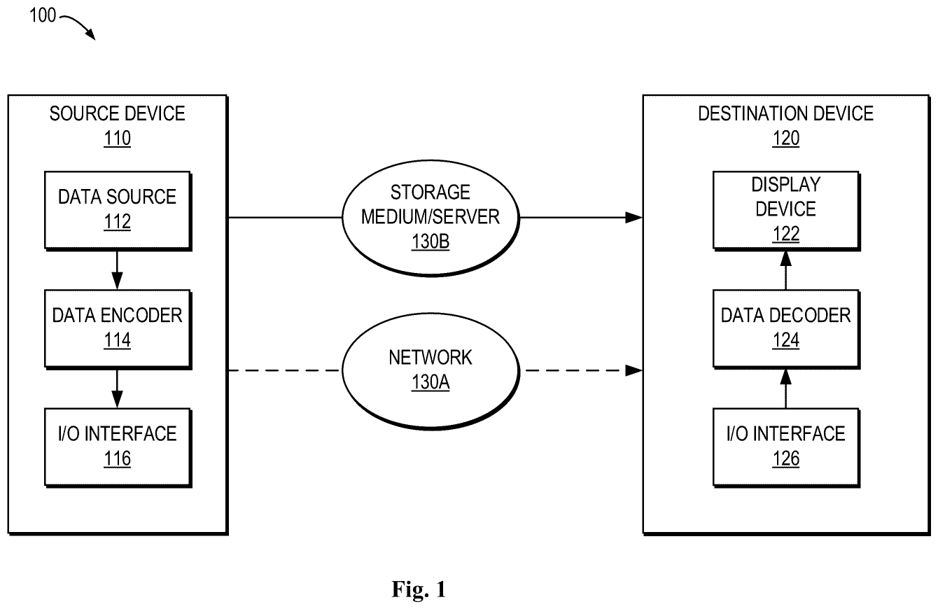

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a data encoding device or a visual data encoding device, and the destination device 120 can be also referred to as a data decoding device or a visual data decoding device. In operation, the source device 110 can be configured to generate encoded visual data and the destination device 120 can be configured to decode the encoded visual data generated by the source device 110. The source device 110 may include a data source 112, a data encoder 114, and an input/output (I/O) interface 116.

The data source 112 may include a source such as a data capture device. Examples of the data capture device include, but are not limited to, an interface to receive data from a data provider, a computer graphics system for generating data, and/or a combination thereof.

The data may comprise one or more pictures of a video or one or more images. The data encoder 114 encodes the data from the data source 112 to generate a bitstream. The bitstream may include a sequence of bits that form a coded representation of the data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded data may be transmitted directly to destination device 120 via the I/O interface 116 through the network 130A. The encoded data may also be stored onto a storage medium/server 130B for access by destination device 120.

The destination device 120 may include an I/O interface 126, a data decoder 124, and a display device 122. The I/O interface 126 may include a receiver and/or a modem. The I/O interface 126 may acquire encoded data from the source device 110 or the storage medium/server 130B. The data decoder 124 may decode the encoded data. The display device 122 may display the decoded data to a user. The display device 122 may be integrated with the destination device 120, or may be external to the destination device 120 which is configured to interface with an external display device.

The data encoder 114 and the data decoder 124 may operate according to a data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific data codecs, the disclosed techniques are applicable to other coding technologies also. Furthermore, while some embodiments describe coding steps in detail, it will be understood that corresponding steps decoding that undo the coding will be implemented by a decoder. Furthermore, the term data processing encompasses data coding or compression, data decoding or decompression and data transcoding in which data are represented from one compressed format into another compressed format or at a different compressed bitrate.

### 1. Brief summary

This disclosure is related to video/image coding technologies. Specifically, it is related to network-based image and video compression. The ideas may be applied individually or in various combinations, to any existing video/image coding standard or non-standard video codec like JPEG-AI and IEEE1857.11. The proposed ideas may be also applicable to future video/image coding standards or video codec.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was proposed originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding remains in its infancy due to the inherent difficulty of the problem.

### 2.1 Image/Video Compression

Image/video compression usually refers to the computing technology that compresses image/video into binary code to facilitate storage and transmission. The binary codes may or may not support lossless reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new disclosure since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature, and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate—log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁. The pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented, where the feed-forward network also has connections skipping the hidden layer, and the parameters are also shared. These approaches perform experiments on the binarized MNIST dataset. NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. NADE and RNADE are improved by using reorganizing the order of the pixels and with deeper neural networks.

Most of the above methods directly model the probability distribution in the pixel domain. Some researchers also attempt to model the probability distribution as a conditional one upon explicit or latent representations. That being said, it may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

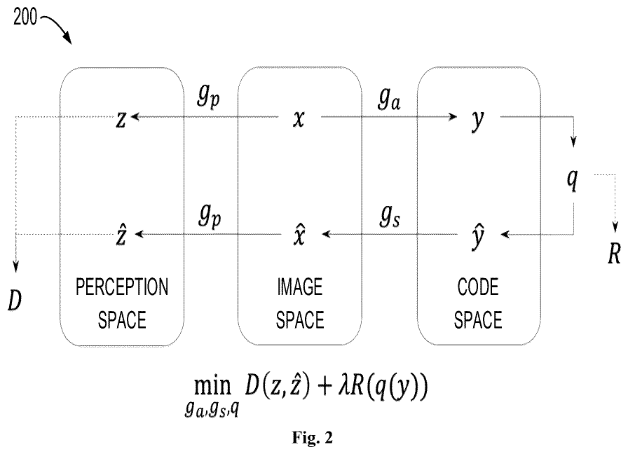

FIG. 2 is a schematic diagram illustrating an example transform coding scheme 200. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

It is intuitive to apply auto-encoder network to lossy image compression. It only needs to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3 Hyper Prior Model

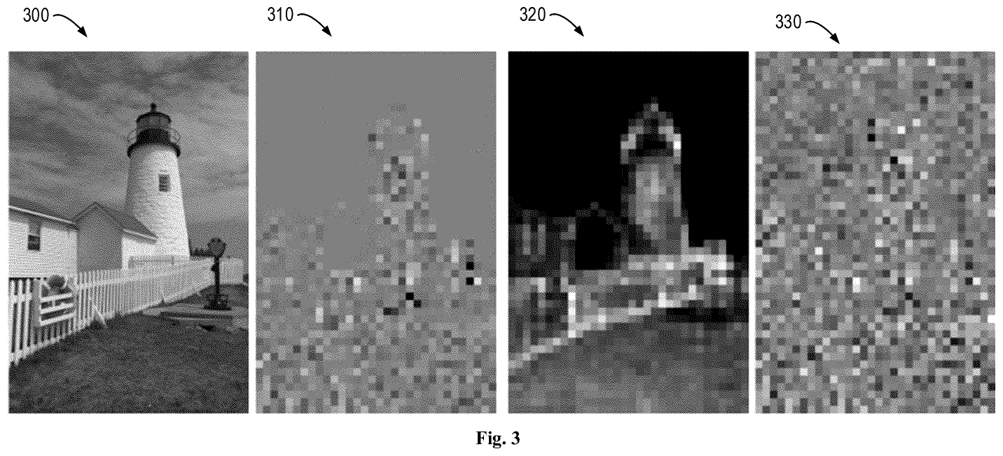

FIG. 3 illustrates example latent representations of an image, including an image 300 from the Kodak dataset, a visualization of the latent 310 representation y of the image 300, a standard deviations σ 320 of the latent 310, and latents y 330 after a hyper prior network is introduced. A hyper prior network includes a hyper encoder and decoder.

In the transform coding approach to image compression, as shown in FIG. 2, the encoder subnetwork (section 2.3.2) transforms the image vector x using a parametric analysis transform gₐ(x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

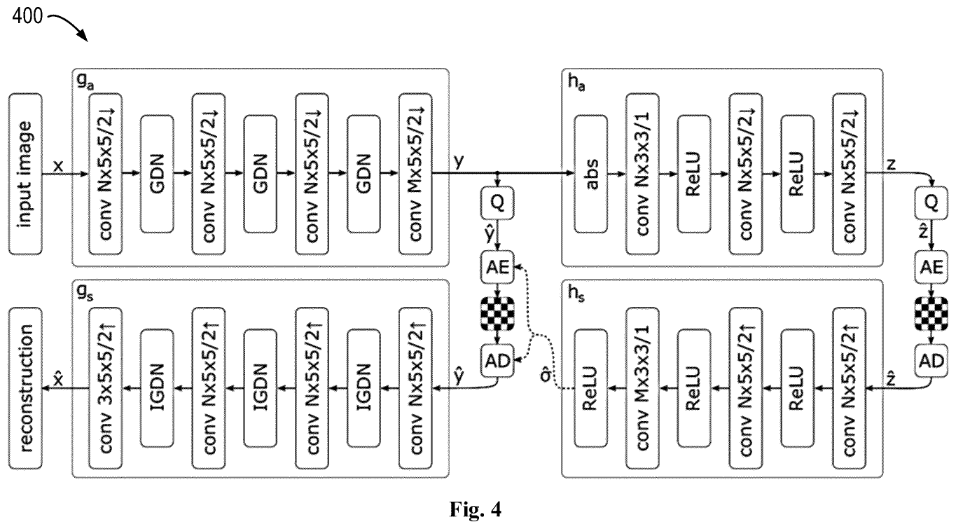

As evident from the latent 310 and the standard deviations σ 320 of FIG. 3, there are significant spatial dependencies among the elements of ŷ. Notably, their scales (standard deviations σ 320) appear to be coupled spatially. An additional set of random variables \hat{z} may be introduced to capture the spatial dependencies and to further reduce the redundancies. In this case the image compression network is depicted in FIG. 4.

FIG. 4 is a schematic diagram 400 illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with ha) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram 400, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 330 in FIG. 3 correspond to the quantized latent when the hyper encoder/decoder are used. Compared to the standard deviations σ 320, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

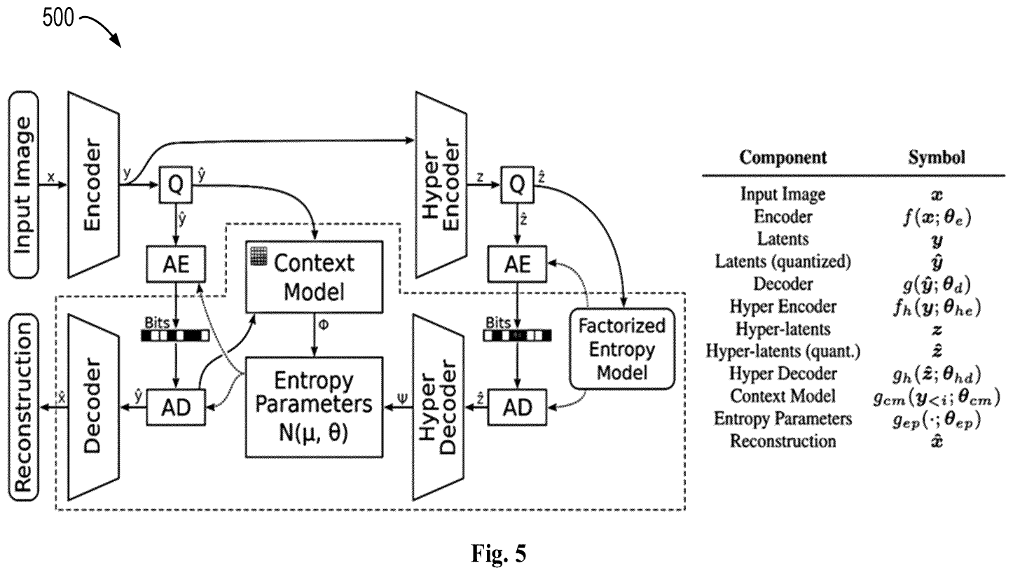

FIG. 5 is a schematic diagram 500 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in schematic diagram 500, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the schematic diagram 500, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0,1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s} .$$

Where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as

$${y}_{s}^{′} = \hat{y} ⊙ {m}_{s}^{′}$$

where ŷ is the decoded quantized latent representation and y′ₛ is the inversely gained quantized latent representation, which will be fed into the synthesis network.

To achieve continuous variable rate adjustment, interpolation is used between vectors. Given two pairs of gain vectors {mₜ, m′ₜ} and {mᵣ, mᵣ′}, the interpolated gain vector can be obtained via the following equations.

$$\begin{matrix}{m}_{ν} = [ {( {m}_{r} )}^{l} \cdot {( {m}_{t} )}^{1 - l} ] \\ {m}_{ν}^{′} = [ {( {m}_{r}^{′} )}^{l} \cdot {( {m}_{t}^{′} )}^{1 - l} ]\end{matrix}$$

where l∈R is an interpolation coefficient, which controls the corresponding bit rate of the generated gain vector pair. Since l is a real number, an arbitrary bit rate between the given two gain vector pairs can be achieved.
2.5.6 The Encoding Process of the Latent Information using Joint Auto-Regressive Hyper Prior Model

The design in FIG. 5. corresponds an example combined compression method. In this section and the next, the encoding and decoding processes are described separately.

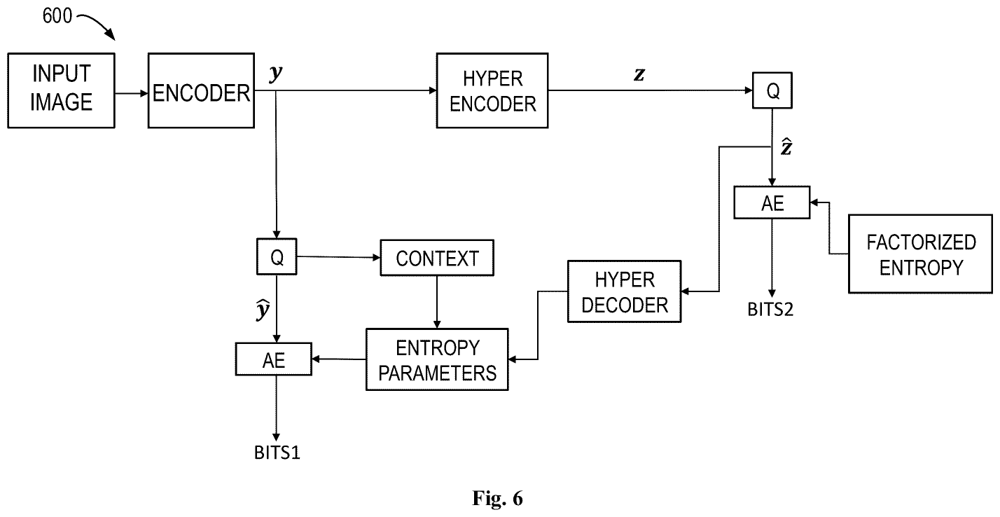

FIG. 6 illustrates an example encoding process 600. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 6 are collectively called encoder. The analysis transform that converts the input image into latent representation is also called an encoder (or auto-encoder).

### 2.3.7 The Decoding Process of the Latent Information using Joint Auto-Regressive Hyper Prior Model

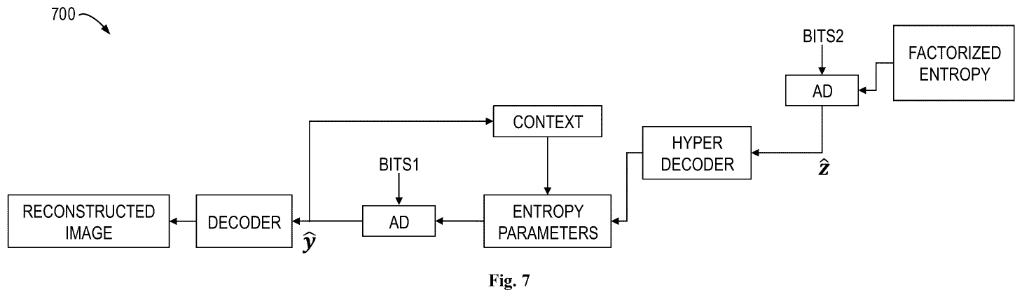

FIG. 7 illustrates an example decoding process 700. FIG. 7 depicts a decoding process separately. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

2.3.8 Encoding and Decoding Procedure with Syntax Element

Besides encoding and decoding latent information that mentioned in 2.3.6 and 2.3.7, some syntax element (e.g., image size, quality parameters, model used in post-processing etc.) are also mandatory in decoding phase, which also needs to be coded in the bitstream. Therefore, the complete encoding procedure of the current learned image compression is as follows.

TABLE 1
Algorithm Description of encoding with syntax element

```
Step1 Encode syntax elements:
  for module_i in module do:
    if module_i has syntax elements that needed to be coded:
        if has_enabled_flag of module_i:
          encode enabled_flag with uniform distribution through AE
      end
        if module_i is enabled in coding procedure:
          for syntax_j in module_i:
            encode syntax_j with uniform distribution through AE
          end
        end
  end
Step2 Encode latent information:
  obtain quantized latent information, and corresponding probability
  distribution
  encode y and z through AE
```

In the encoding procedure, if the current syntax element is needed in the decoding process, it will be encoded through Arithmetic encoder (AE). After the coding of the syntax elements, latent information is also stored into bitstream through the same AE, as it is described in the 2.3.6.

The decoding process with syntax element can be treated as the inverse operation of the encoding process, which is also given in the Table 2.

TABLE 2
Algorithm Description of encoding with syntax element

```
Step1 Decode syntax elements:
  for module_i in module do:
    if module_i has syntax elements that needed to be coded:
        if has_enabled_flag of module_i:
          decode enabled_flag with uniform distribution through AD
      end
        if module_i is enabled in coding procedure:
          for syntax_j in module_i:
            decode syntax_j with uniform distribution through AD
          end
        end
  end
Step2 Decode latent information:
  obtain probability distribution of latent information
  decode y and z based on the probability distribution through AD
```

In the decoding process, Arithmetic Decoder (AD) is utilized to decode all information needed in the decoding procedure. Table 3 gives the syntax elements that might be used in the coding process.

TABLE 3
Syntax element that might be used in the coding process

| Name | Description |
|---|---|
| Image header | Image information(shape, bit depth, file |
| | format etc.) |
| res changer | Parameters for reshape (reshape size etc) |
| icc Profile | Parameter for Profile |
| beta | Scale factor for variable rate |
| active_tool_idx | Model idx |
| tile | Size for tile |
| y_max_symbol | max symbol for arithmetic coding |
| mask_scale | Tools for latent domain operation(scale, |
| | block base skip, etc) |
| LDAO | Parameters for latent domain adaptive optimization |
| wavefront | Parameters for wavefront |
| ICCI | Parameters for post-processing |

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works.

Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . ,255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x× [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x(x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$M S E = \frac{‖ x - \hat{x} {‖}^{2}}{m \times n} \qquad ( 4 )$$

Accordingly, the quality of the reconstructed image compared with the original image can be measured by peak signal-to-noise ratio (PSNR):

$$PSNR = 10 \times l o {g}_{10} \frac{{( max ( 𝔻 ) )}^{2}}{M S E} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 3 Problems

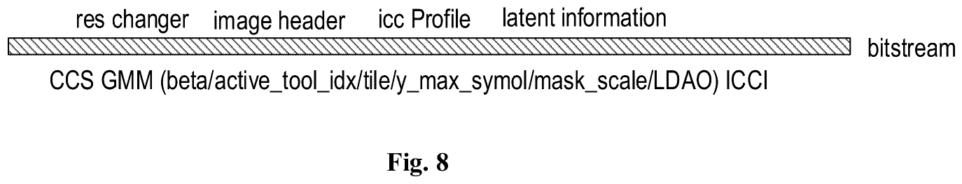

As described in 2.3.8, under the existing image compression framework, all semantic element information and latent information are compressed under the same codeword, which is shown in FIG. 8 which illustrates a structure of the bitstream in the current learned image compression framework.

From FIG. 8, it can be seen that all information is stored in a single codeword without any explicit bitstream structure. Following this structure, if specific information is needed, due to the characteristics of the arithmetic coder, it must first decode all the information that inside the bitstream.

In addition, under the existing framework, luma and chroma information is also stored in the same codeword. When it only needs to decode certain color information, it also needs to decode all the information in the bitstream. This behavior of existing schemes greatly reduces the efficiency of the decoding process, and affect the flexibility and robustness of the bitstream.

Arithmetic coding differs from other forms of entropy encoding, such as Huffman coding, in that rather than separating the input into component symbols and replacing each with a code, arithmetic coding encodes the entire message into a single number (a codeword), an arbitrary-precision fraction q, where 0.0≤q<1.0. A codeword here specifies a bitstream that comprises information about multiple symbols.

The problem with encoding methods such as arithmetic coding is that multiple symbols are encoded into a single codeword (e.g. a single bitstream), and hence it is not possible to decode a specific symbol individually.

A codeword herein might correspond to a bitstream that is the output of an entropy coder or an arithmetic coder or any other form of variable length coder. A codeword typically specifies one or multiple symbols coded into a single bitstream, wherein in order to decode a second symbol in the bitstream, the first symbol also needs to be decoded. This happens for example if the first symbol is coded with variable length coding. In this case, the number of bits used for coding the first symbol can only be determined after the value of the first symbol is decoded. In other words, the starting point of the second symbol in the bitstream can only be determined after the first symbol is decoded. Therefore, the first and the second symbols are said to be comprised within the single codeword (or a single bitstream), since the decoding of the second symbol necessitates decoding of the first symbol. This is also true if the first and the second symbols are coded for example using arithmetic coding.

### 4 Detailed Solutions

The detailed embodiments below should be considered as examples to explain general concepts. These embodiments should not be interpreted in a narrow way. Furthermore, these embodiments can be combined in any manner.

### 4.1 Core of the Disclosure

According to the disclosure, bitstream will be coded with multiple codewords, different codewords are used to represent semantic element information and latent variable information of different color components respectively. Besides, additional byte overhead will be utilized in the bitstream to locate the respective positions of each codeword that contains different information.

### 4.2 Details of Embodiments

1. It is proposed that a (e.g., a first) codeword might be used to record the common syntax elements that are used in the decoding of the luma and chroma components and contain the syntax elements needed to decode luma information.
In one example the image size information (e.g., widths, heights, and bit depth) may be stored in the first codeword.
In one example, resize information (e.g., resized widths, resized heights, resize method) might be stored in the first codeword.
In one example, profile information might be stored in the first codeword.
In one example, parameters for variable rate (e.g., beta in GVAE) might be used in the first codeword.
In one example, quality parameters/model index might be stored in the first codeword.
In one example, parameters for wavefront parallel coding might be stored in the first codeword.
In one example, tile information (e.g., number of the tiles) might be used in the first codeword.
Alternatively, y max symbol may be stored in the first codeword. The y_max_symbol syntax element might identify the maximum symbol value of the quantized latent information, which may be used in the arithmetic coding of the second codeword.
In one example, parameters for the latent domain operation (e.g. scale in latent information, block-based skip in entropy coding) might be stored in the first codeword. Such parameters might include a scalar or a threshold value, which might be used to scale or filter (select) the latent samples in processing.
In one example, latent domain adaptive optimization parameters might be stored in the first codewords.
In one example, tile information for the luma component (e.g., number of tiles) may store in the first codewords.
In one example, parameters for post-processing might be stored in the first codewords.
In one example, all syntax elements stored in the first codewords might be coded through entropy coding.
   In one example, some syntax elements may be coded through arithmetic coding.
      In one example, the uniform distribution might be utilized as the probability distribution of the coded symbol.
      In one example, probability distribution might be calculated through context-adaptive manner.
   In one example, some syntax elements might be coded through fixed-pattern bit string.
   In one example, some syntax elements might be coded through exp-Golomb coding.
   In one example, some syntax elements might be directly coded through unsigned/singed integer.

2. It is proposed that a (e.g., a second) codeword might be used to save the latent variable information of the luma component.
In one example, latent variable information may contain hyperprior information.
In one example, latent variable information may contain residual information.
In one example, latent variable information may be derived from the output of the synthesis network.
In one example, latent variable information may be used as input to a synthesis network.
Additionally, or alternatively, the second codeword might comprise at least 2 codewords, wherein the first one (first codeword of the second codeword) might comprise the hyper prior information and the second one might comprise the residual latent information.

3. It is proposed that a (e.g., a third) codeword might hold the latent variable information of the chroma component. All codewords will be concatenated to form the final bitstream.
In one example, latent variable information may contain hyperprior information.
In one example, latent variable information may contain residual information.
In one example, latent variable information may be derived from the output of the synthesis network.
In one example, latent variable information may be used as input to a synthesis network.
Additionally or alternatively, the third codeword might comprise at least 2 codewords, wherein the first one (first codeword of the third codeword) might comprise the hyper prior information and the second one might comprise the residual latent information.

4. It is proposed that to obtain the location of each codeword in the bitstream, one or multiple bytes will remain at the beginning of the bitstream.
In one example, the relative offset from the initial position will be used to locate the starting position for each part.
In one example, the size of each part might be used to locate the position of each codeword.
In one example, 1/2/4/8/16 bytes might be used to locate the position of one codeword.
In one example, to record the location data, big-endian coding will be utilized.

5. It is proposed that a (e.g., a fourth) codeword might be responsible for storing the high-level syntax information that is needed in the decoding of the chroma components.
In one example, parameters for wavefront parallel coding might be stored in the codeword.
In one example, tile information (e.g., number of the tiles) might be used in the codeword.
In one example, parameters for the latent domain operation (e.g., scale in latent information, block-based skip in entropy coding) might be stored in the codeword.

6. It is proposed that each part of a codeword (e.g., those aforementioned) can be coded in a parallel way.

7. It is proposed that luma-only syntax and/or latent variables can be decoded without decoding chroma information.
In one example, to only decode luma syntax, only the codewords of luma syntax in the bitstream will be decoded, and the parsing of other parts will be skipped.
In one example, to decode luma latent variables, only related codewords will be parsed, and the decoding of the rest parts will be skipped.

8. It is proposed that additional byte alignment might be performed at the end of at least one of the codewords, i.e. if the codeword is not a multiple of 8 bits, stuffing bits might be used to make the length of the codeword multiple of 8 bits. In one example codeword byte alignment might be applied at the end of all codewords.

9. It is proposed that codeword termination might be performed at the end of at least one of the codewords. In one example codeword termination might be applied at the end of all codewords.

10. It is proposed that the arithmetic coding in end-to-end video/image coding may be context based. The probability of a codeword may depend on information already coded/decoded.

11. It is proposed that binarized arithmetic coding may be applied in end-to-end video/image coding.
In one example, context adaptive binarized arithmetic coding (CABAC) coding such as used in H.264/AVC/HEVC/VVC may be applied in entropy coding of end-to-end video/image coding.

### EXAMPLE 1

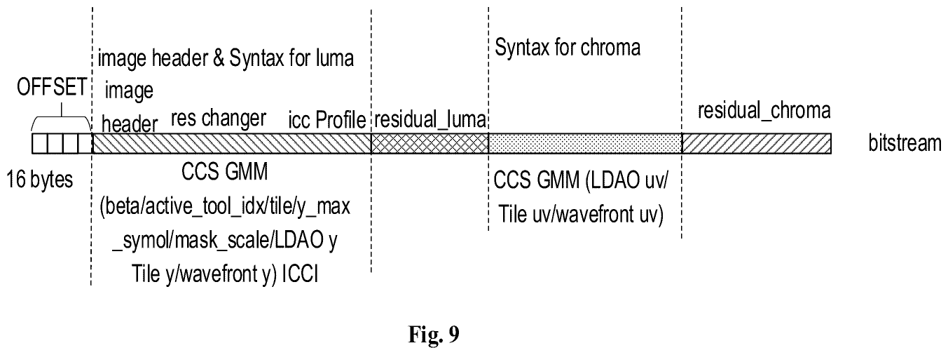

An example of embodiment is depicted in FIG. 9.

According to embodiments of the present disclosure, the bitstream can be divided into 5 parts.
The first part utilize offset to record the position of the rest 4 parts. For each offset, 4 bytes will be utilized to store the value, and it will be written through big-endian coding.
The second part contains common information (image header, res changer, icc profile, y max symbol, mask_scale, ICCI) that might be used in the coding of luma and chroma information. It also contains essential information (LDAO y, Tile y, wavefront y) that used in the coding of luma information. All syntax elements are coded through arithmetic coding with uniform distribution.
The third part contains latent residual information of the luma and related hyperprior information.
The fourth part contains syntax elements (LDAO uv, Tile uv, wavefront uv) hat might only use in the coding of chroma component.
The fifth part contain latent residual information of the chroma and related hyperprior information.

### EXAMPLE 2

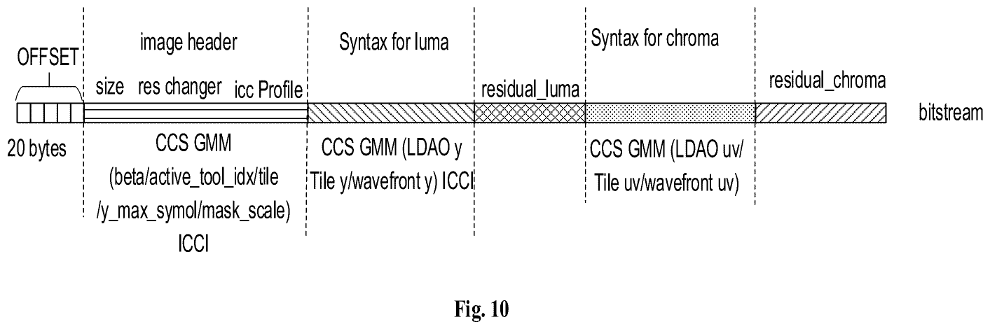

Another example of embodiments of the present disclosure is depicted also in FIG. 10.

According to embodiments of the present disclosure, the bitstream can be divided into 6 parts.
The first part utilize offset to record the position of the rest 5 parts. For each offset, 4 bytes will be utilized to store the value, and it will be written through big-endian coding.
The second part contains common information (image header, res changer, icc profile, y max symbol, mask_scale, ICCI) that might be used in the coding of luma and chroma information. All syntax elements is coded through arithmetic coding with uniform distribution.
The third part contains essential information (LDAO y, Tile y, wavefront y) that used in the coding of luma information. All syntax elements are coded through arithmetic coding with uniform distribution.
The fourth part contains latent residual information of the luma and related hyperprior information.
The fifth part contains syntax elements (LDAO uv, Tile uv, wavefront uv) hat might only use in the coding of chroma component.
The sixth part contain latent residual information of the chroma and related hyperprior information.

### EXAMPLE 3

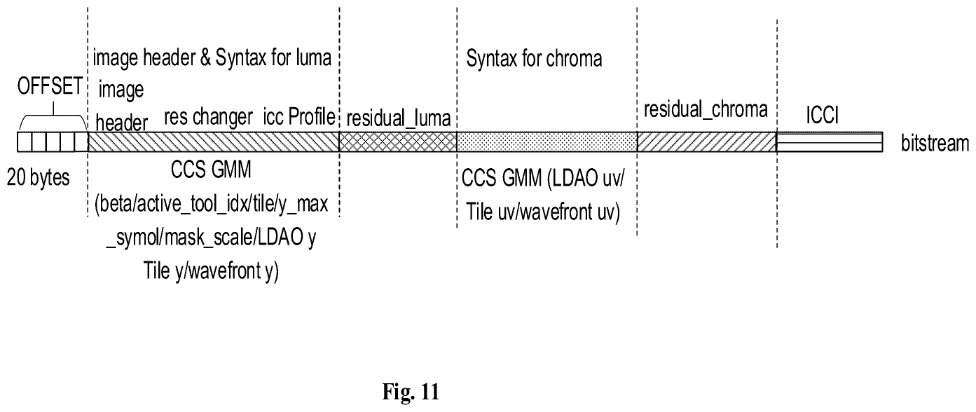

Another example of embodiments of the present disclosure is depicted also in FIG. 11.

According to embodiments of the present disclosure, the bitstream can be divided into 6 parts.
The first part utilize offset to record the position of the rest 5 parts. For each offset, 4 bytes will be utilized to store the value, and it will be written through big-endian coding.
The second part contains common information (image header, res changer, icc profile, y max symbol, mask_scale) that might be used in the coding of luma and chroma information (without post-processing). It also contains essential information (LDAO y, Tile y, wavefront y) that used in the coding of luma information. All syntax elements is coded through arithmetic coding with uniform distribution.
The third part contains latent residual information of the luma and related hyperprior information.
The fourth part contains syntax elements (LDAO uv, Tile uv, wavefront uv) hat might only use in the coding of chroma component.
The fifth part contain information of the chroma and related hyperprior information.
The sixth part contain information for post-processing.

### EXAMPLE 4

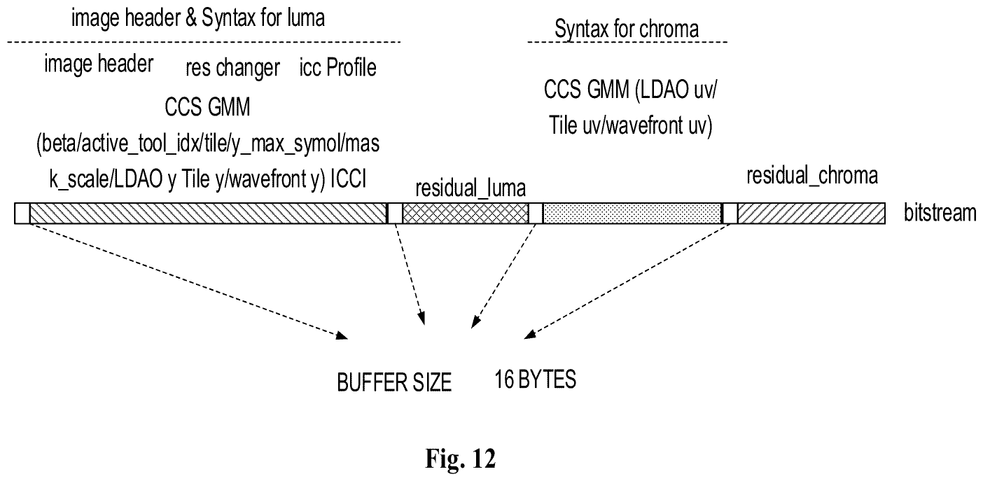

Another example of embodiments of the present disclosure is depicted also in FIG. 12.

According to embodiments of the present disclosure, the bitstream can be divided into 4 parts.
The first part contains common information (image header, res changer, icc profile, y max symbol, mask_scale, ICCI) that might be used in the coding of luma and chroma information. It also contains essential information (LDAO y, Tile y, wavefront y) that used in the coding of luma information. All syntax elements are coded through arithmetic coding with uniform distribution.
The second part contains latent residual information of the luma and related hyperprior information.
The third part contains syntax elements (LDAO uv, Tile uv, wavefront uv) hat might only use in the coding of chroma component.
The fourth part contain latent residual information of the chroma and related hyperprior information.
At the beginning of each part, 4 bytes will be used to record the buffer size of each part.

### 4.3 Benefit of Embodiments

According to embodiments of the present disclosure, structure of the bitstream is redesigned. Based on the function of the syntax elements and latent symbols, bitstream will be divided into serval parts, therefore enables the efficiency of decoding certain elements, and improves the flexibility and robustness of the bitstream.

### 5 Embodiments

1. Decoder:

An image or video decoding method, comprising a neural subnetwork, that comprise the ordered steps of:
Obtaining the location of each codeword in the bitstream,
For codeword that contains syntax elements, decode syntax elements according to the bits,
Based on the syntax elements, construct the structure of the neural network
For codeword that contains latent information, decode latent information according to the bits,
Performing decoding of the latent information, obtaining reconstructed image.

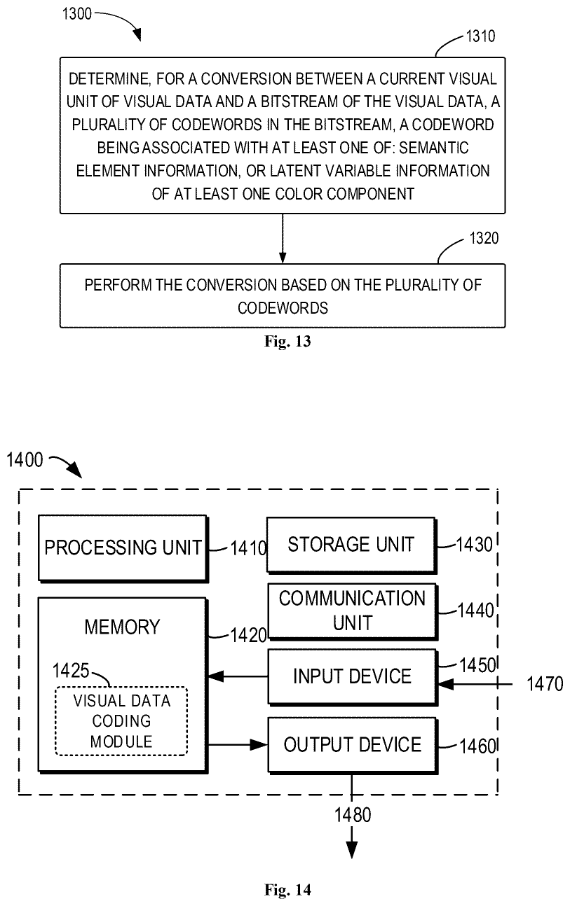

More details will be further discussed below. FIG. 13 illustrates a flowchart of a method 1300 for visual data processing in accordance with embodiments of the present disclosure. The method 1300 is implemented for a conversion between a current visual unit of visual data and a bitstream of the visual data.

At block 1310, a plurality of codewords in the bitstream is determined. A codeword is associated with at least one of: semantic element information, or latent variable information of at least one color component of the current visual unit. At block 1320, the conversion is performed based on the plurality of codewords.

By way of example, the bitstream may be coded with multiple codewords. Different codewords are used to represent semantic element information and latent variable information of different color components respectively. The term “codeword” herein may represent a bitstream unit or bitstream segment which includes or stores at least one syntax element or information. A codeword may be separated from another codeword. As used herein, a “codeword” may be referred to as a “segment in the bitstream”, “a part in the bitstream”, “bitstream segment” or “a unit in the bitstream”. FIG. 9 to FIG. 12 illustrates several example of the bitstream with a plurality of codewords.

The method 1300 enables applying a plurality of codewords instead of a single codeword. For example, these codewords may be processed in parallel. In this way, the coding efficiency and/or coding effectiveness can be improved.

In some embodiments, the plurality of codewords comprises a fist codeword for at least one system element for coding luma information and the at least one color component. For example, the at least one color component comprises at least one of a luma component or a chroma component. In other words, a (e.g., a first) codeword may be used to record the common syntax elements that are used in the decoding of the luma and chroma components and contain the syntax elements needed to decode luma information.

In some embodiments, the first codeword comprises at least one of: image size information of the visual data, resize information of the visual data, profile information, a parameter for a variable rate, a quality parameter, a model index, a parameter for wavefront parallel coding, tile information, a syntax element indicating a maximum symbol value of quantized latent information, a parameter for a latent domain operation, a latent domain adaptive optimization parameter, tile information for a luma component, or a parameter for post-processing.

In some embodiments, the image size information comprises at least one of: a width, a height, or a bit depth.

In some embodiments, the image size information comprises at least one of: a resized width, a resized height, or a resizing tool.

In some embodiments, the tile information comprises the number of tiles.

In some embodiments, the syntax element indicating the maximum symbol value of the quantized latent information is used in arithmetic coding of a second codeword of the plurality of codewords. For example, y max symbol may be stored in the first codeword. The y_max_symbol syntax element might identify the maximum symbol value of the quantized latent information, which may be used in the arithmetic coding of the second codeword.

In some embodiments, the latent domain operation comprises at least one of: a scale in latent information, or a block-based skip in entropy coding, and the parameter for the latent domain operation comprises at least one of: a scaler or a threshold value for scaling or filtering latent samples for processing.

In some embodiments, the tile information for the luma component comprises the number of tiles for the luma component.

In some embodiments, at least one syntax element in the first codeword is coded by at least one of: an entropy coding, an arithmetic coding, a fixed-pattern bit string, or an exponential-Golomb coding.

In some embodiments, the at least one syntax element is coded by the arithmetic coding, and a uniform distribution is used as a probability distribution of the coded at least one syntax element.

In some embodiments, the at least one syntax element is coded by the arithmetic coding, and a probability distribution of the coded at least one syntax element is determined by a context-adaptive manner.

In some embodiments, at least one syntax element in the first codeword is coded by an unsigned or signed integer. For example, some syntax elements might be directly coded through unsigned/singed integer.

In some embodiments, the plurality of codewords comprises at least one second codeword for the latent variable information of a luma component. For example, a (e.g., a second) codeword may be used to save the latent variable information of the luma component.

In some embodiments, the latent variable information of the luma component comprises at least one of: hyperprior information, or residual information.

In some embodiments, the latent variable information of the luma component is determined from an output of a synthesis network for the conversion.

In some embodiments, the latent variable information of the luma component is an input to a synthesis network for the conversion.

In some embodiments, the at least one second codeword comprises a plurality of second codewords, the plurality of second codewords comprising a first second codeword for hyperprior information and a second second codeword for residual latent information.

In some embodiments, the plurality of codewords comprises at least one third codeword for the latent variable information of a chroma component. For example, a (e.g., a third) codeword might hold the latent variable information of the chroma component.

In some embodiments, the latent variable information of the chroma component comprises at least one of: hyperprior information, or residual information.

In some embodiments, the latent information of the chroma component is determined based on an output of a synthesis network for the conversion.

In some embodiments, the latent information of the chroma component is an input of a synthesis network for the conversion.

In some embodiments, the at least one third codeword comprises a plurality of third codewords, the plurality of third codewords comprising a first third codeword for hyperprior information and a second third codeword for residual latent information.

In some embodiments, the method 1300 further comprises: generating the bitstream by concatenating the plurality of codewords. For example, all codewords may be concatenated to form the final bitstream.

In some embodiments, location information of the plurality of codewords is included in the bitstream.

In some embodiments, the location information is included in at least one byte at a beginning of the bitstream. For example, to obtain the location of each codeword in the bitstream, one or multiple bytes will remain at the beginning of the bitstream. Additional byte overhead may be utilized in the bitstream to locate the respective positions of each codeword that contains different information.

In some embodiments, the at least one byte comprises one of: a byte, two bytes, 4 bytes, 8 bytes or 16 bytes.

In some embodiments, the location information comprises a relative offset of a codeword from an initial position in the bitstream, a starting position of the codeword is determined based on the relative offset.

In some embodiments, the location information comprises a size of a codeword, a position of the codeword being determined based on the size.

In some embodiments, the location information is coded by bit-endian coding.

In some embodiments, the plurality of codewords comprises a fourth codeword for high-level syntax information used in coding of a chroma component. For example, a (e.g., a fourth) codeword might be responsible for storing the high-level syntax information that is needed in the decoding of the chroma components.

In some embodiments, the fourth codeword comprises at least one of: a parameter for wavefront parallel coding, tile information, a parameter for a latent domain operation.

In some embodiments, the tile information comprises the number of tiles.

In some embodiments, the latent domain operation comprises at least one of: a scale in latent information, or a block-based skip in entropy coding.

In some embodiments, a byte alignment is performed at an end of a codeword of the plurality of codewords. By way of example, a bit length of the codeword is not a multiple of a predefined bit length, the byte alignment is performed at the end of the codeword by adding stuffing bits, a bit length of the aligned codeword being of a multiple of the predefined bit length. For example, the predefined bit length may be 8 bits. That is, additional byte alignment may be performed at the end of at least one of the codewords, i.e. if the codeword is not a multiple of 8 bits, stuffing bits might be used to make the length of the codeword multiple of 8 bits. In one example codeword byte alignment might be applied at the end of all codewords.

In some embodiments, a codeword termination is performed at at least one end of at least one codeword in the plurality of codewords.

In some embodiments, a codeword termination is performed at a respective end of each of the plurality of codewords.

In some embodiments, the plurality of codewords is coded in parallel.

In some embodiments, at least one of: a first syntax element for a luma component or a second syntax element for a luma latent variable is coded without coding chroma information.

In some embodiments, a codeword for the first syntax element in the bitstream is coded without parsing of other codewords in the bitstream.

In some embodiments, a codeword related to the luma latent variable is coded without coding other codewords in the bitstream.

In some embodiments, the conversion is performed by an end-to-end video or image coding, and an arithmetic coding used in the end-to-end video or image coding is context based.

In some embodiments, a probability of a codeword of the plurality of codewords is based on coded information.

In some embodiments, the conversion is performed by an end-to-end video or image coding, and a binarized arithmetic coding is applied in the end-to-end video or image coding.

In some embodiments, the binarized arithmetic coding comprises a context adaptive binarized arithmetic coding (CABAC), and the CABAC is applied in entropy coding of the end-to-end video or image coding. For example, CABAC coding such as that used in H.264/AVC/HEVC/VVC may be applied in entropy coding of end-to-end video/image coding.

In some embodiments, the conversion comprises decoding the current visual unit from the bitstream.

In some embodiments, performing the conversion comprises: determining respective locations of the plurality of codewords in the bitstream; for a codeword with at least one syntax element of the plurality of codewords, decoding the at least one syntax element based on the bitstream; determining a structure of a neural network for the conversion based on the decoded at least one syntax element; for a further codeword with latent information of the plurality of codewords, decoding the latent information based on the bitstream; and determining a reconstructed image based on the decoded latent information.

In some embodiments, the conversion comprises encoding the current visual unit into the bitstream.

According to further embodiments of the present disclosure, a non-transitory computer-readable recording medium is provided. The non-transitory computer-readable recording medium stores a bitstream of visual data which is generated by a method performed by an apparatus for visual data processing. In the method, a plurality of codewords in the bitstream is determined. A codeword is associated with at least one of: semantic element information, or latent variable information of at least one color component of a current visual unit of the visual data. The bitstream is generated based on the plurality of codewords.

According to still further embodiments of the present disclosure, a method for storing bitstream of visual data is provided. In the method, a plurality of codewords in the bitstream is determined. A codeword is associated with at least one of: semantic element information, or latent variable information of at least one color component of a current visual unit of the visual data. The bitstream is generated based on the plurality of codewords. The bitstream is stored in a non-transitory computer-readable recording medium.

Implementations of the present disclosure can be described in view of the following clauses, the features of which can be combined in any reasonable manner.

Clause 1. A method for visual data processing, comprising: determining, for a conversion between a current visual unit of visual data and a bitstream of the visual data, a plurality of codewords in the bitstream, a codeword being associated with at least one of: semantic element information, or latent variable information of at least one color component; and performing the conversion based on the plurality of codewords.

Clause 2. The method of clause 1, wherein the plurality of codewords comprises a fist codeword for at least one system element for coding luma information and the at least one color component.

Clause 3. The method of clause 2, wherein the at least one color component comprises at least one of a luma component or a chroma component.

Clause 4. The method of clause 2 or 3, wherein the first codeword comprises at least one of: image size information of the visual data, resize information of the visual data, profile information, a parameter for a variable rate, a quality parameter, a model index, a parameter for wavefront parallel coding, tile information, a syntax element indicating a maximum symbol value of quantized latent information, a parameter for a latent domain operation, a latent domain adaptive optimization parameter, tile information for a luma component, or a parameter for post-processing.

Clause 5. The method of clause 4, wherein the image size information comprises at least one of: a width, a height, or a bit depth.

Clause 6. The method of clause 4, wherein the image size information comprises at least one of: a resized width, a resized height, or a resizing tool.

Clause 7. The method of clause 4, wherein the tile information comprises the number of tiles.

Clause 8. The method of clause 4, wherein the syntax element indicating the maximum symbol value of the quantized latent information is used in arithmetic coding of a second codeword of the plurality of codewords.

Clause 9. The method of clause 4, wherein the latent domain operation comprises at least one of: a scale in latent information, or a block-based skip in entropy coding, and the parameter for the latent domain operation comprises at least one of: a scaler or a threshold value for scaling or filtering latent samples for processing.

Clause 10. The method of clause 4, wherein the tile information for the luma component comprises the number of tiles for the luma component.

Clause 11. The method of any of clauses 2-10, wherein at least one syntax element in the first codeword is coded by at least one of: an entropy coding, an arithmetic coding, a fixed-pattern bit string, or an exponential-Golomb coding.

Clause 12. The method of clause 11, wherein the at least one syntax element is coded by the arithmetic coding, and a uniform distribution is used as a probability distribution of the coded at least one syntax element.

Clause 13. The method of clause 11, wherein the at least one syntax element is coded by the arithmetic coding, and a probability distribution of the coded at least one syntax element is determined by a context-adaptive manner.

Clause 14. The method of any of clauses 2-10, wherein at least one syntax element in the first codeword is coded by an unsigned or signed integer.

Clause 15. The method of any of clauses 1-14, wherein the plurality of codewords comprises at least one second codeword for the latent variable information of a luma component.

Clause 16. The method of clause 15, wherein the latent variable information of the luma component comprises at least one of: hyperprior information, or residual information.

Clause 17. The method of clause 15 or 16, wherein the latent variable information of the luma component is determined from an output of a synthesis network for the conversion.

Clause 18. The method of clause 15 or 16, wherein the latent variable information of the luma component is an input to a synthesis network for the conversion.

Clause 19. The method of any of clauses 15-18, wherein the at least one second codeword comprises a plurality of second codewords, the plurality of second codewords comprising a first second codeword for hyperprior information and a second second codeword for residual latent information.

Clause 20. The method of any of clauses 1-19, wherein the plurality of codewords comprises at least one third codeword for the latent variable information of a chroma component.

Clause 21. The method of clause 20, wherein the latent variable information of the chroma component comprises at least one of: hyperprior information, or residual information.

Clause 22. The method of clause 20 or 21, wherein the latent information of the chroma component is determined based on an output of a synthesis network for the conversion.

Clause 23. The method of clause 20 or 21, wherein the latent information of the chroma component is an input of a synthesis network for the conversion.

Clause 24. The method of any of clauses 20-23, wherein the at least one third codeword comprises a plurality of third codewords, the plurality of third codewords comprising a first third codeword for hyperprior information and a second third codeword for residual latent information.

Clause 25. The method of any of clauses 1-24, further comprising: generating the bitstream by concatenating the plurality of codewords.

Clause 26. The method of any of clauses 1-25, wherein location information of the plurality of codewords is included in the bitstream.

Clause 27. The method of clause 26, wherein the location information is included in at least one byte at a beginning of the bitstream.

Clause 28. The method of clause 27, wherein the at least one byte comprises one of: a byte, two bytes, 4 bytes, 8 bytes or 16 bytes.

Clause 29. The method of any of clauses 26-28, wherein the location information comprises a relative offset of a codeword from an initial position in the bitstream, a starting position of the codeword is determined based on the relative offset.

Clause 30. The method of any of clauses 26-28, wherein the location information comprises a size of a codeword, a position of the codeword being determined based on the size.

Clause 31. The method of any of clauses 26-30, wherein the location information is coded by bit-endian coding.

Clause 32. The method of any of clauses 1-31, wherein the plurality of codewords comprises a fourth codeword for high-level syntax information used in coding of a chroma component.

Clause 33. The method of clause 32, wherein the fourth codeword comprises at least one of: a parameter for wavefront parallel coding, tile information, a parameter for a latent domain operation.

Clause 34. The method of clause 33, wherein the tile information comprises the number of tiles.

Clause 35. The method of clause 33, wherein the latent domain operation comprises at least one of: a scale in latent information, or a block-based skip in entropy coding.

Clause 36. The method of any of clauses 1-35, wherein a byte alignment is performed at an end of a codeword of the plurality of codewords.

Clause 37. The method of clause 36, wherein a bit length of the codeword is not a multiple of a predefined bit length, the byte alignment is performed at the end of the codeword by adding stuffing bits, a bit length of the aligned codeword being of a multiple of the predefined bit length.

Clause 38. The method of clause 37, wherein the predefined bit length is 8 bits.

Clause 39. The method of any of clauses 1-38, wherein a codeword termination is performed at at least one end of at least one codeword in the plurality of codewords.

Clause 40. The method of any of clauses 1-38, wherein a codeword termination is performed at a respective end of each of the plurality of codewords.

Clause 41. The method of any of clauses 1-40, wherein the plurality of codewords is coded in parallel.

Clause 42. The method of any of clauses 1-41, wherein at least one of: a first syntax element for a luma component or a second syntax element for a luma latent variable is coded without coding chroma information.

Clause 43. The method of clause 42, wherein a codeword for the first syntax element in the bitstream is coded without parsing of other codewords in the bitstream.

Clause 44. The method of clause 42, wherein a codeword related to the luma latent variable is coded without coding other codewords in the bitstream.

Clause 45. The method of any of clauses 1-44, wherein the conversion is performed by an end-to-end video or image coding, and an arithmetic coding used in the end-to-end video or image coding is context based.

Clause 46. The method of clause 45, wherein a probability of a codeword of the plurality of codewords is based on coded information.

Clause 47. The method of any of clauses 1-46, wherein the conversion is performed by an end-to-end video or image coding, and a binarized arithmetic coding is applied in the end-to-end video or image coding.

Clause 48. The method of clause 47, wherein the binarized arithmetic coding comprises a context adaptive binarized arithmetic coding (CABAC), and the CABAC is applied in entropy coding of the end-to-end video or image coding.

Clause 49. The method of any of clauses 1-48, wherein the conversion comprises decoding the current visual unit from the bitstream.

Clause 50. The method of clause 49, wherein performing the conversion comprises: determining respective locations of the plurality of codewords in the bitstream; for a codeword with at least one syntax element of the plurality of codewords, decoding the at least one syntax element based on the bitstream; determining a structure of a neural network for the conversion based on the decoded at least one syntax element; for a further codeword with latent information of the plurality of codewords, decoding the latent information based on the bitstream; and determining a reconstructed image based on the decoded latent information.

Clause 51. The method of any of clauses 1-48, wherein the conversion comprises encoding the current visual unit into the bitstream.

Clause 52. An apparatus for visual data processing comprising a processor and a non-transitory memory with instructions thereon, wherein the instructions upon execution by the processor, cause the processor to perform a method in accordance with any of clauses 1-51.

Clause 53. A non-transitory computer-readable storage medium storing instructions that cause a processor to perform a method in accordance with any of clauses 1-51.

Clause 54. A non-transitory computer-readable recording medium storing a bitstream of visual data which is generated by a method performed by an apparatus for visual data processing, wherein the method comprises: determining a plurality of codewords in the bitstream, a codeword being associated with at least one of: semantic element information, or latent variable information of at least one color component of a current visual unit of the visual data; and generating the bitstream based on the plurality of codewords.

Clause 55. A method for storing a bitstream of visual data, comprising: determining a plurality of codewords in the bitstream, a codeword being associated with at least one of: semantic element information, or latent variable information of at least one color component of a current visual unit of the visual data; generating the bitstream based on the plurality of codewords; and storing the bitstream in a non-transitory computer-readable recording medium.

### Example Device

FIG. 14 illustrates a block diagram of a computing device 1400 in which various embodiments of the present disclosure can be implemented. The computing device 1400 may be implemented as or included in the source device 110 (or the data encoder 114) or the destination device 120 (or the data decoder 124).

It would be appreciated that the computing device 1400 shown in FIG. 14 is merely for purpose of illustration, without suggesting any limitation to the functions and scopes of the embodiments of the present disclosure in any manner.

As shown in FIG. 14, the computing device 1400 includes a general-purpose computing device 1400. The computing device 1400 may at least comprise one or more processors or processing units 1410, a memory 1420, a storage unit 1430, one or more communication units 1440, one or more input devices 1450, and one or more output devices 1460.

In some embodiments, the computing device 1400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1400 can support any type of interface to a user (such as “wearable” circuitry and the like).

The processing unit 1410 may be a physical or virtual processor and can implement various processes based on programs stored in the memory 1420. In a multi-processor system, multiple processing units execute computer executable instructions in parallel so as to improve the parallel processing capability of the computing device 1400. The processing unit 1410 may also be referred to as a central processing unit (CPU), a microprocessor, a controller or a microcontroller.

The computing device 1400 typically includes various computer storage medium. Such medium can be any medium accessible by the computing device 1400, including, but not limited to, volatile and non-volatile medium, or detachable and non-detachable medium. The memory 1420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1430 may be any detachable or non-detachable medium and may include a machine-readable medium such as a memory, flash memory drive, magnetic disk or another other media, which can be used for storing information and/or data and can be accessed in the computing device 1400.

The computing device 1400 may further include additional detachable/non-detachable, volatile/non-volatile memory medium. Although not shown in FIG. 14, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1440 communicates with a further computing device via the communication medium. In addition, the functions of the components in the computing device 1400 can be implemented by a single computing cluster or multiple computing machines that can communicate via communication connections. Therefore, the computing device 1400 can operate in a networked environment using a logical connection with one or more other servers, networked personal computers (PCs) or further general network nodes.

The input device 1450 may be one or more of a variety of input devices, such as a mouse, keyboard, tracking ball, voice-input device, and the like. The output device 1460 may be one or more of a variety of output devices, such as a display, loudspeaker, printer, and the like. By means of the communication unit 1440, the computing device 1400 can further communicate with one or more external devices (not shown) such as the storage devices and display device, with one or more devices enabling the user to interact with the computing device 1400, or any devices (such as a network card, a modem and the like) enabling the computing device 1400 to communicate with one or more other computing devices, if required. Such communication can be performed via input/output (I/O) interfaces (not shown).

In some embodiments, instead of being integrated in a single device, some or all components of the computing device 1400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1400 may be used to implement visual data encoding/decoding in embodiments of the present disclosure. The memory 1420 may include one or more visual data coding modules 1425 having one or more program instructions. These modules are accessible and executable by the processing unit 1410 to perform the functionalities of the various embodiments described herein.

In the example embodiments of performing visual data encoding, the input device 1450 may receive visual data as an input 1470 to be encoded. The visual data may be processed, for example, by the visual data coding module 1425, to generate an encoded bitstream. The encoded bitstream may be provided via the output device 1460 as an output 1480.

In the example embodiments of performing visual data decoding, the input device 1450 may receive an encoded bitstream as the input 1470. The encoded bitstream may be processed, for example, by the visual data coding module 1425, to generate decoded visual data. The decoded visual data may be provided via the output device 1460 as the output 1480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for visual data processing, comprising:
determining, for a conversion between a current visual unit of visual data and a bitstream of the visual data, a plurality of codewords in the bitstream, a codeword being associated with at least one of: semantic element information, or latent variable information of at least one color component of the current visual unit; and
performing the conversion based on the plurality of codewords.

2. The method of claim 1, wherein the plurality of codewords comprises a fist codeword for at least one system element for coding luma information and the at least one color component, wherein the at least one color component comprises at least one of a luma component or a chroma component.

3. The method of claim 2, wherein the first codeword comprises at least one of:
image size information of the visual data,
resize information of the visual data,
profile information,
a parameter for a variable rate,
a quality parameter,
a model index,
a parameter for wavefront parallel coding,
tile information,
a syntax element indicating a maximum symbol value of quantized latent information,
a parameter for a latent domain operation,
a latent domain adaptive optimization parameter,
tile information for a luma component, or
a parameter for post-processing.

4. The method of claim 3, wherein the image size information comprises at least one of: a width, a height, or a bit depth, or
wherein the image size information comprises at least one of: a resized width, a resized height, or a resizing tool, or
wherein the tile information comprises the number of tiles, or
wherein the syntax element indicating the maximum symbol value of the quantized latent information is used in arithmetic coding of a second codeword of the plurality of codewords, or
wherein the latent domain operation comprises at least one of: a scale in latent information, or a block-based skip in entropy coding, and the parameter for the latent domain operation comprises at least one of: a scaler or a threshold value for scaling or filtering latent samples for processing, or
wherein the tile information for the luma component comprises the number of tiles for the luma component.

5. The method of claim 2, wherein at least one syntax element in the first codeword is coded by an unsigned or signed integer.

6. The method of claim 1, wherein the plurality of codewords comprises at least one second codeword for the latent variable information of a luma component,
wherein the latent variable information of the luma component comprises residual information.

7. The method of claim 1, wherein the plurality of codewords comprises at least one third codeword for the latent variable information of a chroma component,
wherein the latent variable information of the chroma component comprises residual information.

8. The method of claim 1, further comprising:
generating the bitstream by concatenating the plurality of codewords.

9. The method of claim 1, wherein location information of the plurality of codewords is included in the bitstream.

10. The method of claim 9, wherein the location information is included in at least one byte at a beginning of the bitstream, wherein the at least one byte comprises 4 bytes, or
wherein the location information comprises a relative offset of a codeword from an initial position in the bitstream, a starting position of the codeword is determined based on the relative offset, or
wherein the location information comprises a size of a codeword, a position of the codeword being determined based on the size.

11. The method of claim 1, wherein the plurality of codewords comprises a fourth codeword for high-level syntax information used in coding of a chroma component,
wherein the fourth codeword comprises at least one of: a parameter for wavefront parallel coding, tile information, a parameter for a latent domain operation.

12. The method of claim 11, wherein the tile information comprises the number of tiles, and/or
wherein the latent domain operation comprises at least one of: a scale in latent information, or a block-based skip in entropy coding.

13. The method of claim 1 wherein a byte alignment is performed at an end of a codeword of the plurality of codewords,
wherein a bit length of the codeword is not a multiple of a predefined bit length, the byte alignment is performed at the end of the codeword by adding stuffing bits, a bit length of the aligned codeword being of a multiple of the predefined bit length, wherein the predefined bit length is 8 bits.

14. The method of claim 1, wherein a codeword termination is performed at at least one end of at least one codeword in the plurality of codewords, or
wherein a codeword termination is performed at a respective end of each of the plurality of codewords.

15. The method of claim 1, wherein the conversion comprises decoding the current visual unit from the bitstream.

16. The method of claim 15, wherein performing the conversion comprises:
determining respective locations of the plurality of codewords in the bitstream;
for a codeword with at least one syntax element of the plurality of codewords, decoding the at least one syntax element based on the bitstream;
determining a structure of a neural network for the conversion based on the decoded at least one syntax element;
for a further codeword with latent information of the plurality of codewords, decoding the latent information based on the bitstream; and
determining a reconstructed image based on the decoded latent information.

17. The method of claim 1, wherein the conversion comprises encoding the current visual unit into the bitstream.

18. An apparatus for visual data processing comprising a processor and a non-transitory memory with instructions thereon, wherein the instructions upon execution by the processor, cause the processor to:
determine, for a conversion between a current visual unit of visual data and a bitstream of the visual data, a plurality of codewords in the bitstream, a codeword being associated with at least one of: semantic element information, or latent variable information of at least one color component of the current visual unit; and
perform the conversion based on the plurality of codewords.

19. A non-transitory computer-readable storage medium storing instructions that cause a processor to perform acts comprising:
determining, for a conversion between a current visual unit of visual data and a bitstream of the visual data, a plurality of codewords in the bitstream, a codeword being associated with at least one of: semantic element information, or latent variable information of at least one color component of the current visual unit; and
performing the conversion based on the plurality of codewords.

20. A non-transitory computer-readable recording medium storing a bitstream of visual data which is generated by a method performed by an apparatus for visual data processing, wherein the method comprises:
determining a plurality of codewords in the bitstream, a codeword being associated with at least one of: semantic element information, or latent variable information of at least one color component of a current visual unit of the visual data; and
generating the bitstream based on the plurality of codewords.
